(19) United States
(12) Patent Application Publication
(10) Pub. No.: US 2026/0204212 A1
(43) Pub. Date: Jul. 16, 2026

(54) POWER SOURCE CIRCUIT AND DRIVING METHOD THEREFOR, AND DISPLAY APPARATUS

(71) Applicant: BOE TECHNOLOGY GROUP CO., LTD., Beijing (CN)

(72) Inventors: Fei YANG, Beijing (CN); Tangxiang WANG, Beijing (CN); Yu WANG, Beijing (CN); Yi CHEN, Beijing (CN); Jingbo XU, Beijing (CN)

(21) Appl. No.: 18/720,724

(22) PCT Filed: Dec. 29, 2021
(86) PCT No.: PCT/CN2021/142705

§ 371 Date: Jun. 17, 2024

(51) Int. Cl. G09G 3/3233

(52) U.S. Cl. CPC G09G 3/3233; G09G 2300/0842; G09G 2330/021

(57) ABSTRACT

A power circuit, a method for driving the same, and a display device are provided. The power circuit is applied to a display device including a driving circuit configured to input a reset image to a display panel under an effect of a first polarity signal. The power circuit includes: a voltage input terminal configured to provide a power voltage to the display panel during a power-on phase, and stop providing the power voltage during a power-off phase; a first unidirectional conduction circuit configured to: transmit a signal from the voltage input terminal to a first output terminal, and block a signal from the first output terminal to the voltage input terminal; a storage circuit configured to store a charge of the first output terminal; and a detection circuit configured to input the first polarity signal to the driving circuit when the voltage input terminal loses power.

### CROSS-REFERENCE TO RELATED APPLICATION

The present application is a U.S. national phase application of International Application No. PCT/CN2021/142705, filed on Dec. 29, 2021, the entire contents of which are hereby incorporated by reference in its entirety.

### TECHNICAL FIELD

The present disclosure relates to the field of display technology, and in particular, to a power circuit, a method for driving the power circuit, and a display device.

### BACKGROUND

In related art, when the display panel is powered off, residual charges on the display panel may cause threshold shifts in the driving transistors of the pixel driving circuits, leading to display issues such as image retention.

It should be noted that the information disclosed above in the “BACKGROUND” section is only intended to enhance understanding of the background of the present disclosure, and therefore may include information that does not constitue existing technologies known to those of ordinary skill in the art.

### SUMMARY

According to an aspect of the present disclosure, a power circuit is provided for use in a display device. The display device includes a display panel and a driving circuit, where the driving circuit is configured to provide a source driving signal generated based on display data, and a gate driving signal to the display panel, and input a reset image to the display panel under an effect of a first polarity signal. The power circuit includes: a voltage input terminal, a first unidirectional conduction circuit, a storage circuit, and a detection circuit. The voltage input terminal is configured to provide a power voltage to the display panel during a power-on phase, and stop providing the power voltage during a power-off phase. The first unidirectional conduction circuit is connected between the voltage input terminal and a first output terminal, and configured to transmit a signal from the voltage input terminal to the first output terminal and block a signal from the first output terminal to the voltage input terminal. The storage circuit is connected to the first output terminal and configured to store a charge of the first output terminal. The detection circuit is connected to the voltage input terminal and the driving circuit, and configured to input the first polarity signal to the driving circuit when the voltage input terminal loses power.

In an exemplary embodiment of the present disclosure, the display device further includes a light-emitting voltage circuit configured to provide the display panel with a power voltage required by the display panel. The voltage input terminal is connected to the light-emitting voltage circuit and configured to provide the light-emitting voltage circuit with a power voltage required by the light-emitting voltage circuit.

In an exemplary embodiment of the present disclosure, the display device may further include a system circuit configured to provide the display data to the driving circuit. The voltage input terminal is connected to the system circuit and configured to provide the system circuit with a power voltage required by the system circuit.

In an exemplary embodiment of the present disclosure, the power circuit further includes: a second unidirectional conduction circuit connected between the voltage input terminal and a second output terminal, and configured to transmit a signal from the voltage input terminal to the second output terminal and block a signal from the second output terminal to the voltage input terminal, where the second output terminal is configured to provide the light-emitting voltage circuit with the power voltage required by the light-emitting voltage circuit.

In an exemplary embodiment of the present disclosure, the power circuit further includes: a third unidirectional conduction circuit connected between the voltage input terminal and a third output terminal, and configured to transmit a signal from the voltage input terminal to the third output terminal and block a signal from the third output terminal to the voltage input terminal, where the third output terminal is configured to provide the system circuit with the power voltage required by the system circuit.

In an exemplary embodiment of the present disclosure, the display device may further include a system circuit, which is configured to provide the display data to the driving circuit. The voltage input terminal is connected to the system circuit and configured to provide the system circuit with a power voltage required by the system circuit. The power circuit further includes a second unidirectional conduction circuit and a third unidirectional conduction circuit. The second unidirectional conduction circuit is connected between the voltage input terminal and a second output terminal, and configured to transmit a signal from the voltage input terminal to the second output terminal, and block a signal from the second output terminal to the voltage input terminal. The second output terminal is configured to provide the light-emitting voltage circuit with the power voltage required by the light-emitting voltage circuit. The third unidirectional conduction circuit is connected between the voltage input terminal and a third output terminal, and is configured to transmit a signal from the voltage input terminal to the third output terminal, and block a signal from the third output terminal to the voltage input terminal. The third output terminal is configured to provide the system circuit with the power voltage required by the system circuit. The first unidirectional conduction circuit includes at least one first diode. At least one first diode is connected in series between the voltage input terminal and the first output terminal, with an anode of the at least one first diode connected to the voltage input terminal and a cathode of the at least one first diode connected to the first output terminal. The second unidirectional conduction circuit includes at least one second diode. At least one second diode is connected in series between the voltage input terminal and the second output terminal, with an anode of the at least one second diode connected to the voltage input terminal and a cathode of the at least one second diode connected to the second output terminal. The third unidirectional conduction circuit includes at least one third diode. At least one third diode is connected in series between the voltage input terminal and the third output terminal, with an anode of the at least one third diode connected to the voltage input terminal and a cathode of the at least one third diode connected to the third output terminal.

In an exemplary embodiment of the present disclosure, the number of the at least one first diode, the number of the at least one second diode, and the number of the at least one third diode are equal; or the number of the at least one first diode, the number of the at least one second diode, and the number of the at least one third diode are not all equal.

In an exemplary embodiment of the present disclosure, the storage circuit includes a capacitor connected to the first output terminal.

In an exemplary embodiment of the present disclosure, the detection circuit includes a first resistor and a second resistor, where the first resistor is connected between the voltage input terminal and a first node, and the second resistor is connected between the first node and a ground terminal. The first node is configured to provide the first polarity signal to the driving circuit.

In an exemplary embodiment of the present disclosure, the reset image is a black image.

In an exemplary embodiment of the present disclosure, voltages of source driving signals corresponding to all sub-pixels in the reset image are equal.

In an exemplary embodiment of the present disclosure, the voltages of the source driving signals corresponding to all sub-pixels in the reset image are zero.

According to an aspect of the present disclosure, a method for driving a power circuit is provided, which is configured to drive the power circuit described above. The driving method includes: providing a power voltage to the voltage input terminal during the power-on phase of the display panel, and allowing the display panel to display normally under an action of the driving circuit; and stopping providing the power voltage to the voltage input terminal during the power-off phase of the display panel, inputting, by the detection circuit, the first polarity signal to the driving circuit, and providing, by the driving circuit, the reset image to the display panel under an effect of a voltage of the storage circuit stored at the first output terminal.

In an exemplary embodiment of the present disclosure, when the voltage input terminal is connected to the system circuit and the light-emitting voltage circuit in the display device, the driving method includes: providing the power voltage to the voltage input terminal during the power-on phase of the display panel, providing, by the system circuit, the display data to the driving circuit, and providing, by the light-emitting voltage circuit, the display panel with a power voltage required by the display panel; and stopping providing the power voltage to the voltage input terminal during the power-off phase of the display panel, stopping, by the system circuit, providing the display data to the driving circuit, and stopping, by the light-emitting voltage circuit, providing the power voltage required by the display panel to the display panel.

According to an aspect of the present disclosure, a display device is provided, where the display device includes: a display panel, a driving circuit, and the power circuit described above. The driving circuit is configured to provide a source driving signal generated based on display data, and a gate driving signal to the display panel, and input a reset image to the display panel under an effect of a first polarity signal.

In an exemplary embodiment of the present disclosure, the display device further includes a light-emitting voltage circuit and a system circuit. The light-emitting voltage circuit is configured to provide the display panel with a power voltage required by the display panel, and the system circuit is configured to provide the display data to the driving circuit, where the driving circuit is configured to provide the source driving signal to the display panel based on the display data.

According to an aspect of the present disclosure, a display device is provided, where the display device includes: a display panel, a driving circuit, and a power circuit. The driving circuit is configured to: provide a source driving signal generated based on display data, and a gate driving signal to the display panel, and input a reset image to the display panel under an effect of a first polarity signal. The power circuit is configured to provide a power voltage to the driving circuit during a power-on phase of the display panel, provide the first polarity signal to the driving circuit during a power-off phase of the display panel, and provide a power voltage to the driving circuit within a preset duration after the power-off of the display panel.

In an exemplary embodiment of the present disclosure, the display device further includes a light-emitting voltage circuit and a system circuit. The light-emitting voltage circuit is configured to provide the display panel with a power voltage required by the display panel. The system circuit is configured to provide the display data to the driving circuit, where the driving circuit is configured to provide the source driving signal to the display panel based on the display data. The power circuit is further configured to provide a power voltage to the light-emitting voltage circuit during the power-on phase of the display panel; and stop providing the power voltage to the light-emitting voltage circuit during the power-off phase of the display panel. Additionally, the power circuit is further configured to provide a power voltage to the system circuit during the power-on phase of the display panel; and stop providing the power voltage to the system circuit during the power-off phase of the display panel.

It should be understood that the general description above and the detailed description that follows are merely exemplary and explanatory and should not be construed to limit the present disclosure.

### BRIEF DESCRIPTION OF THE DRAWINGS

The drawings included herein are incorporated into and form part of this specification, which illustrate embodiments consistent with the present disclosure and are used in conjunction with the specification to explain the principles of the present disclosure. It is obvious that the drawings described below are only some embodiments of the present disclosure and for those of ordinary skill in the art, other drawings can be obtained based on these drawings without creative efforts.

FIG. 1 is a schematic diagram of a structure of a pixel driving circuit in a display panel according to the present disclosure.

FIG. 2 is a schematic diagram of a structure of a display device in related art.

FIG. 3 is a schematic diagram of a structure of a display device according to an exemplary embodiment of the present disclosure.

FIG. 4 is a schematic diagram of a structure of a display device according to another exemplary embodiment of the present disclosure.

FIG. 5 is a timing diagram of partial nodes during the driving process of the display device shown in FIG. 4.

FIG. 6 is a schematic diagram of a structure of a display device according to another exemplary embodiment of the present disclosure.

FIG. 7 is a schematic diagram of a structure of a display device according to another exemplary embodiment of the present disclosure.

FIG. 8 is a schematic diagram of a partial structure of a display device according to another exemplary embodiment of the present disclosure.

### DETAILED DESCRIPTION

Exemplary embodiments will now be described more fully with reference to the drawings. However, the exemplary embodiments can be implemented in various forms and should not be construed as being limited to the examples set forth herein. Rather, these embodiments are provided so that this disclosure will be more thorough and complete, and will fully convey the concept of the exemplary embodiments to those skilled in the art. The same reference numerals in the drawings represent the same or similar structures, and thus their detailed descriptions will be omitted.

The terms “a”, “an”, and “the” are used to indicate the presence of one or more elements/components, etc. The terms “including/comprising” and “having” are used to indicate an open-ended inclusion, meaning that in addition to the listed elements/components, etc., there may be other elements/components, etc.

As shown in FIG. 1, it is a schematic diagram of a structure of a pixel driving circuit in a display panel according to the present disclosure. The pixel driving circuit includes a driving transistor DT, a switch transistor T1, and a capacitor C. A first electrode of the driving transistor DT is connected to a first power supply terminal VDD. A first electrode of the switch transistor T1 is connected to a data signal terminal Da, a second electrode of the switch transistor T1 is connected to a gate of the driving transistor, a gate of the switch transistor T1 is connected to a gate driving signal terminal Gate. The capacitor C is connected between a gate of the driving transistor DT and a second electrode of the driving transistor. The pixel driving circuit is configured to drive a light-emitting unit OLED in the display panel to emit light. The light-emitting unit OLED is connected between the second electrode of the driving transistor DT and a second power supply terminal VSS. The switch transistor T1 and the driving transistor DT may be N-type transistors.

A method for driving the the pixel driving circuit may include a data writing phase and a light-emitting phase. In the data writing phase, a gate driving signal on the gate driving signal terminal Gate is set to a high level, the switch transistor T1 is turned on to transmit a source driving signal from the data signal terminal Da to the gate of the driving transistor DT. In the light-emitting phase, the switch transistor T1 is turned off, and the driving transistor DT provides a driving current to the light-emitting unit OLED under its gate voltage, causing the light-emitting unit OLED to emit light.

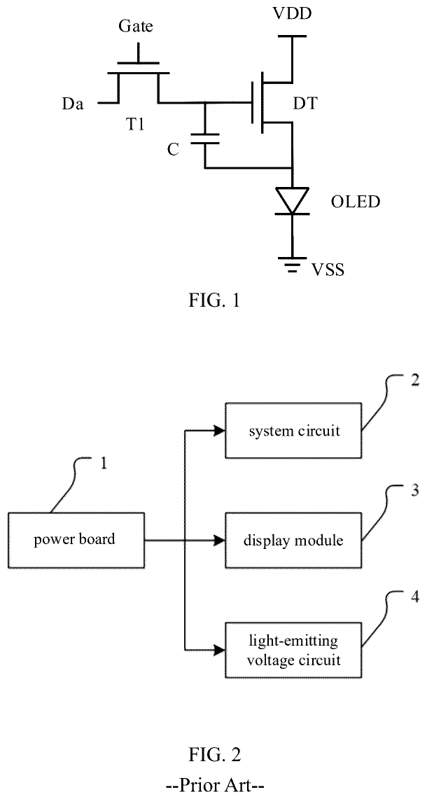

As shown in FIG. 2, it is a schematic diagram of a structure of a display device in related art. The display device includes a power board 1, a system circuit 2, a display module 3, and a light-emitting voltage circuit 4. The power board 1 can provide the required power voltages to the system circuit 2, the display module 3, and the light-emitting voltage circuit 4, respectively. The display module 3 may include a display panel and a driving circuit. The system circuit 2 can provide display data to the driving circuit according to the display image to be displayed. The driving circuit can provide the source driving signals to the display panel based on the display data, along with the corresponding gate driving signals. The light-emitting voltage circuit 4 can provide the power voltage to the display panel, i.e., the light-emitting voltage circuit 4 can provide the first power supply terminal VDD shown in FIG. 1 to the pixel driving circuit in the display panel. However, when the display panel is powered off, the power board 1 stops providing the power voltages to the system circuit 2, the display module 3, and the light-emitting voltage circuit 4. At this time, there may be residual source driving signals in the gate of the driving transistor in the pixel driving circuit. The driving transistor may experience threshold shift under the long-term effect of these source driving signals, leading to display issues such as image persistence when the display panel is powered on next time.

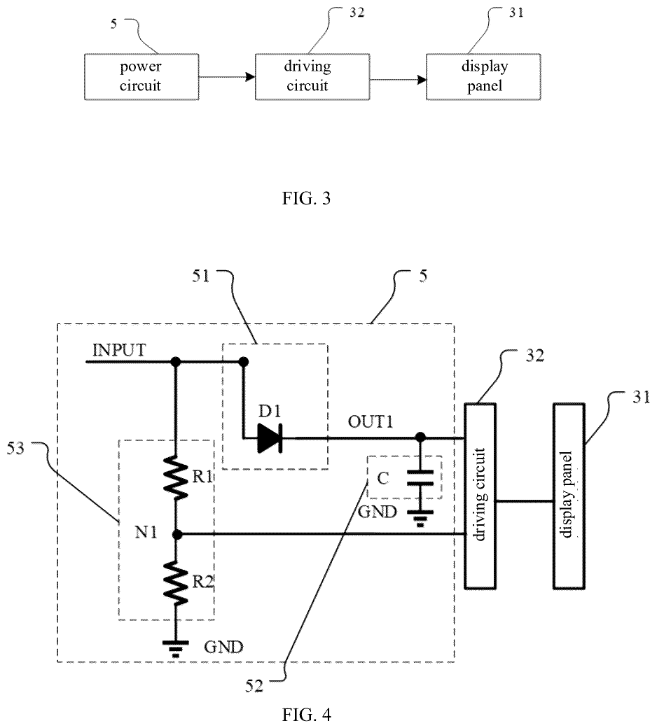

Based on this, according to an exemplary embodiment, a display device is provided. As shown in FIG. 3, it is a schematic diagram of a structure of a display device according to an exemplary embodiment of the present disclosure. The display device may include: a display panel 31, a driving circuit 32, and a power circuit 5. The driving circuit 32 is configured to provide a source driving signal generated based on display data, and a gate driving signal to the display panel 31, and to input a reset image to the display panel 31 under the effect of a first polarity signal. The power circuit 5 is configured to provide a power voltage to the driving circuit 32 during the power-on phase of the display panel, to provide the first polarity signal to the driving circuit 32 during the power-off phase of the display panel, and to provide a power voltage to the driving circuit 32 within a preset duration after the display panel is powered off.

The power-off phase of the display panel refers to the period when the power voltage is stopped being provided to the display panel, i.e., the period when the power voltage is stopped being provided to the first power supply terminal of the pixel driving circuit. Correspondingly, the power-on phase of the display panel refers to the period when the power voltage is provided to the display panel, i.e., the period when the power voltage is provided to the first power supply terminal of the pixel driving circuit.

In this exemplary embodiment, when the display device is during the power-on phase of the display panel, the pixel driving circuit in the display panel can display images normally under the effect of the gate driving signal and the source driving signal provided by the driving circuit 32. When the display device in within the preset duration after the display panel is powered off, the driving circuit 32 can provide a reset image to the display panel, where the voltage of the source driving signal corresponding to each sub-pixel unit in the reset image can be zero. This allows the reset signal to reset the gate voltage of the driving transistor in each pixel driving circuit to zero, thereby avoiding threshold shift of the driving transistor and improving the display effect of the display panel.

It should be understood that in other exemplary embodiments, the voltage of the source driving signal corresponding to each sub-pixel unit in the reset image can also be set to other values. When the voltages of the source driving signals corresponding to all sub-pixel units in the reset image are equal, it can ensure that each driving transistor has the same degree of threshold shift, thereby improving the display effect of the display panel to some extent. Additionally, when the reset image is a black image, the display panel can display a black image after being powered off due to the residual charge on the power line, achieving a shutdown black screen. The power line is used to provide power voltage to each pixel driving circuit in the display panel, for example, the power line can provide a high-level power voltage to the first power supply terminal shown in FIG. 1.

It should be noted that the pixel driving circuit of the display device in the present disclosure, may be as shown in FIG. 1. When the voltage of the source driving signal corresponding to each sub-pixel unit in the reset image is zero, the reset image is a black image. It should be understood that in other exemplary embodiments, the pixel driving circuit in the display device may have other structures, such as 7T1C, 8T1C, etc., and the driving transistors can also be P-type transistors.

In this exemplary embodiment, the driving circuit 32 may include multiple circuits that are used to drive the normal display of the display panel. For example, the driving circuit 32 may include a source driving circuit, a gate driving circuit, a gamma circuit, etc. The driving circuit 32 can provide the required power voltages to the source driving circuit, gate driving circuit, gamma circuit, etc. The driving circuit 32 may be integrated into the timing controller (TCOM) of the display device, and the logical function of the driving circuit 32 to input a reset image to the display panel 31 under the effect of a first polarity signal can be achieved by programming the programmable logic gate array on the timing controller.

As shown in FIG. 4, it is a schematic diagram of a structure of a display device according to another exemplary embodiment of the present disclosure. The power circuit 5 may include: a voltage input terminal INPUT, a first unidirectional conduction circuit 51, a storage circuit 52, and a detection circuit 53. The voltage input terminal INPUT is configured to provide the power voltage during the power-on phase of the display panel and to stop providing the power voltage during the power-off phase of the display panel. The first unidirectional conduction circuit 51 is connected between the voltage input terminal INPUT and a first output terminal OUT1. The first unidirectional conduction circuit 51 is configured to transmit the signal from the voltage input terminal INPUT to the first output terminal OUT1 and to block a signal from the first output terminal OUT1 to the voltage input terminal INPUT. The storage circuit 52 is connected to the first output terminal OUT1, and is configured to store the charge of the first output terminal OUT1. The detection circuit 53 is connected to the voltage input terminal INPUT and the driving circuit 32, and is configured to input the first polarity signal to the driving circuit 32 when the voltage input terminal INPUT loses power.

In this exemplary embodiment, as shown in FIG. 4, the first unidirectional conduction circuit 51 may include a first diode D1, where an anode of the first diode D1 is connected to the voltage input terminal INPUT, and a cathode of the first diode D1 is connected to the first output terminal OUT1. The storage circuit 52 may include a capacitor C, where one electrode of the capacitor C is connected to the first output terminal OUT1, and the other electrode of the capacitor C can be connected to the ground terminal GND. The detection circuit 53 may include a first resistor R1 and a second resistor R2, where the first resistor R1 is connected between the voltage input terminal INPUT and the first node N1, and the second resistor R2 is connected between the first node N1 and the ground terminal GND. The first node N1 is used to provide the first polarity signal to the driving circuit 32. This first polarity signal can be a low-level signal.

The power circuit may also include a power board, which can be used to provide the power voltage to the voltage input terminal INPUT.

In this exemplary embodiment, as shown in FIG. 5, it is a timing diagram of partial nodes during the driving process of the display device shown in FIG. 4. In this figure, INPUT represents the timing diagram of the voltage input terminal, and OUT1 represents the timing diagram of the first output terminal. During the power-on phase t1 of the display panel, the power voltage can be provided to the voltage input terminal INPUT, and the voltage input terminal INPUT provides the required power voltage to the driving circuit 32 through the first diode D1, allowing the display panel 31 to display normally under the action of the driving circuit 32. During the power-off phase t2 of the display panel, the power voltage to the voltage input terminal INPUT can be stopped, causing the voltage input terminal INPUT to quickly drop to a low level. At this time, the voltage of the first node N1 also quickly drops to a low level, and the first node N1 provides a low-level first polarity signal to the driving circuit 32. The first output terminal OUT1 maintains a high level for a certain duration due to the effect of the capacitor C. Under the high level of the first output terminal OUT1, the driving circuit 32 provides a reset image to the display panel 31 to reset the gate of the driving transistor in the display panel. The larger the capacitance value of the capacitor C, the longer the duration the first output terminal OUT1 maintains a high level after the display panel is powered off, allowing the driving circuit to provide more frames of reset images to the display panel. In this exemplary embodiment, the driving circuit 32 can provide at least two frames of reset images to the display panel 31 under the voltage stored in the capacitor C. It should be understood that in other exemplary embodiments, the driving circuit 32 can also provide one frame of reset image to the display panel 31 under the voltage stored in the capacitor C.

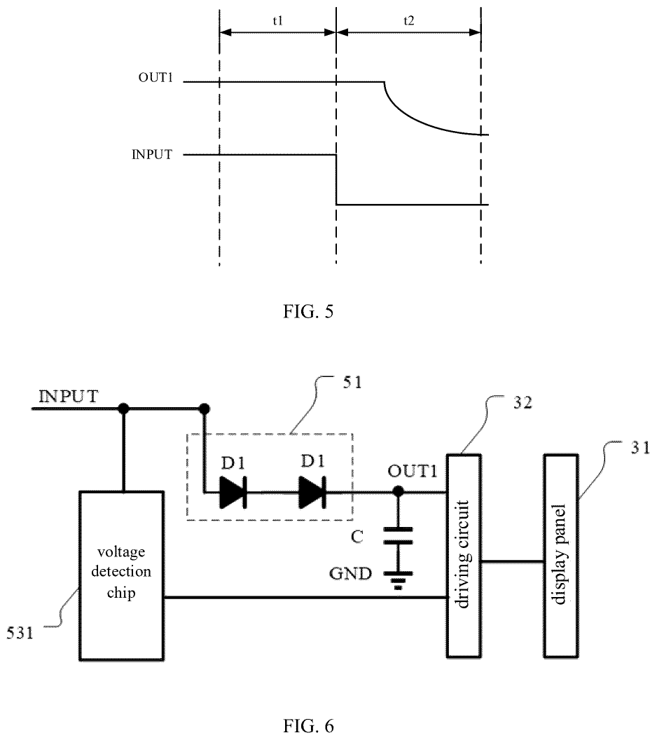

It should be understood that in other exemplary embodiments, the first unidirectional conduction circuit 51, storage circuit 52, and detection circuit 53 may have other structures. For example, as shown in FIG. 6, it is a schematic diagram of a structure of a display device according to another exemplary embodiment of the present disclosure. The first unidirectional conduction circuit 51 may include multiple first diodes D1 connected in series between the voltage input terminal INPUT and the first output terminal OUT, where the anode of the first one of the first diodes D1 is connected to the voltage input terminal INPUT, and the cathode of the last one of the first diodes D1 is connected to the first output terminal OUT. The multiple diodes connected in series can be understood as multiple diodes connected in sequence, with the anode of one diode connected to the cathode of the adjacent diode. In this exemplary embodiment, the voltage of the first output terminal OUT1 can be adjusted by adjusting the number of first diodes. The detection circuit 53 can also be implemented through a voltage detection chip 531. The voltage detection chip 531 has the function of outputting high and low levels according to the voltage polarity.

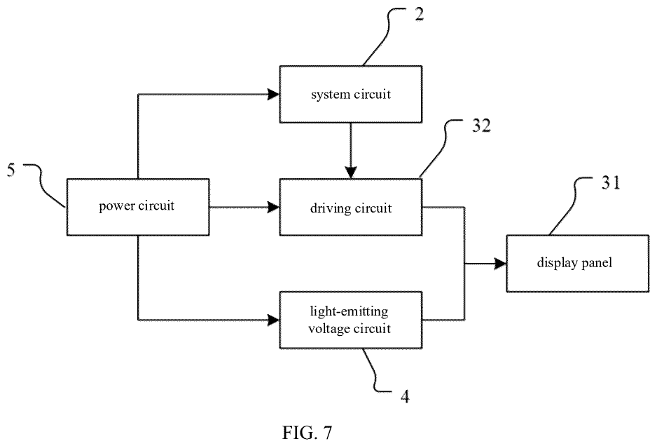

In this exemplary embodiment, as shown in FIG. 7, it is a schematic diagram of a structure of a display device according to another exemplary embodiment of the present disclosure. The display device further includes a light-emitting voltage circuit 4 and a system circuit 2. The light-emitting voltage circuit 4 is configured to provide the display panel with the power voltage required by the display panel. The system circuit 2 is configured to provide display data to the driving circuit 32, where the driving circuit 32 is configured to use the gamma circuit and source driving circuit in the driving circuit 32 to provide the source driving signals to the display panel based on the display data. The power circuit 5 is also configured to provide the power voltage to the light-emitting voltage circuit 4 during the power-on phase of the display panel, and to stop providing the power voltage to the light-emitting voltage circuit 4 during the power-off phase of the display panel. The power circuit 5 is further configured to provide the power voltage to the system circuit 2 during the power-on phase of the display panel, and to stop providing the power voltage to the system circuit 2 during the power-off phase of the display panel. In this exemplary embodiment, by using a single power circuit 5 to provide the respective power voltages required by the light-emitting voltage circuit 4, the driving circuit 32, and the system circuit 2, the cost of the display device can be reduced. It should be understood that in other exemplary embodiments, different power circuits can be used to provide the power voltages to the light-emitting voltage circuit 4, the driving circuit 32, and the system circuit 2.

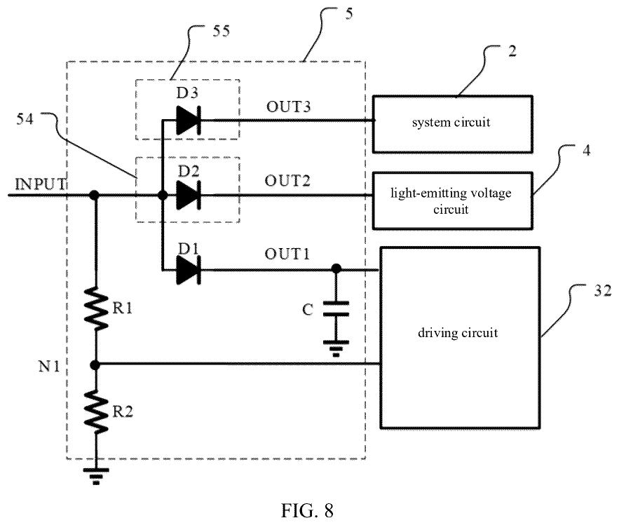

In this exemplary embodiment, as shown in FIG. 8, it is a schematic diagram of a partial structure of a display device according to another exemplary embodiment of the present disclosure. FIG. 8 does not show the display panel, but the connection and interaction between the display panel and other circuits in the display device can be the same as the display device shown in FIG. 7. The power circuit 5 may also include a second unidirectional conduction circuit 54 and a third unidirectional conduction circuit 55. The second unidirectional conduction circuit 54 is connected between the voltage input terminal INPUT and the second output terminal OUT2. The second unidirectional conduction circuit 54 is configured to transmit the signal from the voltage input terminal INPUT to the second output terminal OUT2, and to block the signal from the second output terminal OUT2 to the voltage input terminal INPUT. The second output terminal OUT2 is configured to provide the light-emitting voltage circuit 4 with the power voltage required by the light-emitting voltage circuit 4. The third unidirectional conduction circuit 55 is connected between the voltage input terminal INPUT and the third output terminal OUT3. The third unidirectional conduction circuit 55 is configured to transmit the signal from the voltage input terminal INPUT to the third output terminal OUT3, and to block the signal from the third output terminal OUT3 to the voltage input terminal INPUT. The third output terminal OUT3 is configured to provide the system circuit 2 with the power voltage required by the system circuit 2.

In this exemplary embodiment, the second unidirectional conduction circuit 54 and the third unidirectional conduction circuit 55 can isolate voltage interference between the first output terminal OUT1, the second output terminal OUT2, and the third output terminal OUT3, thus improving the stability of the power circuit 5 in providing power to the light-emitting voltage circuit 4, driving circuit 32, and system circuit 2.

As shown in FIG. 8, the second unidirectional conduction circuit 54 may include a second diode D2, where the anode of the second diode D2 is connected to the voltage input terminal INPUT, and the cathode of the second diode D2 is connected to the second output terminal OUT2. The third unidirectional conduction circuit 55 may include a third diode D3, where the anode of the third diode D3 is connected to the voltage input terminal INPUT, and the cathode of the third diode D3 is connected to the third output terminal OUT3.

It should be understood that in other exemplary embodiments, the second unidirectional conduction circuit 54 and the third unidirectional conduction circuit 55 may have other structures. For example, the second unidirectional conduction circuit 54 may include multiple second diodes connected in series between the voltage input terminal INPUT and the second output terminal OUT2. The voltage input terminal INPUT can be connected to the anode of the first one of the second diodes, and the second output terminal OUT2 can be connected to the cathode of the last one of the second diodes, with the anode of one second diode connected to the cathode of the adjacent second diode. The third unidirectional conduction circuit 55 may include multiple third diodes connected in series between the voltage input terminal INPUT and the third output terminal OUT3. The voltage input terminal INPUT can be connected to the anode of the first one of the third diodes, and the third output terminal OUT3 can be connected to the cathode of the last one of the third diodes, with the anode of one third diode connected to the cathode of the adjacent third diode. In this exemplary embodiment, the voltage of the second output terminal can be adjusted by adjusting the number of second diodes, and the voltage of the third output terminal can be adjusted by adjusting the number of third diodes. In this exemplary embodiment, the quantities of the first diodes, second diodes, and third diodes can be the same, or they can be different.

It should be understood that in other exemplary embodiments, the voltages of the first output terminal OUT1, the second output terminal OUT2, and the third output terminal OUT3 in the power circuit 5 can also be adjusted in other ways. For example, the voltage of each output terminal can be adjusted by connecting resistors in series between the voltage input terminal INPUT and each output terminal.

In this exemplary embodiment, the display device can be a desktop monitor, laptop, or any other type of display device.

In this exemplary embodiment, a method for driving a power circuit is also provided. The method is used to drive the power circuit described above, and the method includes:
providing a power voltage to the voltage input terminal during the power-on phase of the display panel, and allowing the display panel to display normally under an action of the driving circuit; and
stopping providing the power voltage to the voltage input terminal during the power-off phase of the display panel, inputting, by the detection circuit, the first polarity signal to the driving circuit, and providing, by the driving circuit, the reset image to the display panel under an action of a voltage of the storage circuit stored at the first output terminal.

In this exemplary embodiment, when the voltage input terminal is connected to a system circuit and a light-emitting voltage circuit in the display device, the method further includes:
providing the power voltage to the voltage input terminal during the power-on phase of the display panel, providing, by the system circuit, the display data to the driving circuit, and providing, by the light-emitting voltage circuit, the display panel with a power voltage required by the display panel; and
stopping providing the power voltage to the voltage input terminal during the power-off phase of the display panel, stopping, by the system circuit, providing the display data to the driving circuit, and stopping, by the light-emitting voltage circuit, providing the power voltage required by the display panel to the display panel.

The detailed explanation of the method for driving the power circuit has been provided in the above content and will not be repeated here.

Those skilled in the art will readily conceive of other embodiments or variations of the present disclosure based on the description and practice of the content disclosed herein. The scope of the present disclosure is intended to cover any modifications, uses, or adaptations following the general principles of the disclosure and including common knowledge or conventional techniques in the technical field not disclosed in the present disclosure. The specification and embodiments are only exemplary, and the true scope and spirit of the present disclosure are indicated by the claims.

It should be understood that the present disclosure is not limited to the precise structures described and illustrated in the accompanying drawings, and various modifications and changes can be made without departing from the scope thereof. The scope of the present disclosure is defined by the appended claims.

1. A power circuit for a display device, wherein the display device comprises: a display panel, and a driving circuit configured to: provide a source driving signal generated based on display data, and a gate driving signal to the display panel, and input a reset image to the display panel under an effect of a first polarity signal; and the power circuit comprises:
a voltage input terminal configured to: provide a power voltage to the display panel during a power-on phase, and stop providing the power voltage during a power-off phase;
a first unidirectional conduction circuit connected between the voltage input terminal and a first output terminal, and configured to: transmit a signal from the voltage input terminal to the first output terminal, and block a signal from the first output terminal to the voltage input terminal;
a storage circuit connected to the first output terminal, and configured to store a charge of the first output terminal; and
a detection circuit connected to the voltage input terminal and the driving circuit, and configured to input the first polarity signal to the driving circuit when the voltage input terminal loses power.

2. The power circuit of claim 1, wherein the display device further comprises a light-emitting voltage circuit configured to provide the display panel with a power voltage required by the display panel; and
the voltage input terminal is connected to the light-emitting voltage circuit and configured to provide the light-emitting voltage circuit with a power voltage required by the light-emitting voltage circuit.

3. The power circuit of claim 1, wherein the display device further comprises a system circuit configured to provide the display data to the driving circuit; and
the voltage input terminal is connected to the system circuit and configured to provide the system circuit with a power voltage required by the system circuit.

4. The power circuit of claim 2, further comprising:
a second unidirectional conduction circuit connected between the voltage input terminal and a second output terminal, and configured to: transmit a signal from the voltage input terminal to the second output terminal, and block a signal from the second output terminal to the voltage input terminal;
wherein the second output terminal is configured to provide the light-emitting voltage circuit with the power voltage required by the light-emitting voltage circuit.

5. The power circuit of claim 3, further comprising:
a third unidirectional conduction circuit connected between the voltage input terminal and a third output terminal, and configured to: transmit a signal from the voltage input terminal to the third output terminal, and block a signal from the third output terminal to the voltage input terminal;
wherein the third output terminal is configured to provide the system circuit with the power voltage required by the system circuit.

6. The power circuit of claim 2, wherein the display device further comprises a system circuit configured to provide the display data to the driving circuit; and
the voltage input terminal is connected to the system circuit and configured to provide the system circuit with a power voltage required by the system circuit; and the power circuit further comprises:
a second unidirectional conduction circuit connected between the voltage input terminal and a second output terminal, and configured to: transmit a signal from the voltage input terminal to the second output terminal, and block a signal from the second output terminal to the voltage input terminal, wherein the second output terminal is configured to provide the light-emitting voltage circuit with the power voltage required by the light-emitting voltage circuit; and
a third unidirectional conduction circuit connected between the voltage input terminal and a third output terminal, and configured to: transmit a signal from the voltage input terminal to the third output terminal, and block a signal from the third output terminal to the voltage input terminal, wherein the third output terminal is configured to provide the system circuit with the power voltage required by the system circuit;
wherein the first unidirectional conduction circuit comprises:
at least one first diode connected in series between the voltage input terminal and the first output terminal, with an anode of the at least one first diode connected to the voltage input terminal and a cathode of the at least one first diode connected to the first output terminal;
wherein the second unidirectional conduction circuit comprises:
at least one second diode connected in series between the voltage input terminal and the second output terminal, with an anode of the at least one second diode connected to the voltage input terminal and a cathode of the at least one second diode connected to the second output terminal; and
wherein the third unidirectional conduction circuit comprises:
at least one third diode connected in series between the voltage input terminal and the third output terminal, with an anode of the at least one third diode connected to the voltage input terminal and a cathode of the at least one third diode connected to the third output terminal.

7. The power circuit of claim 6, wherein the number of the at least one first diode, the number of the at least one second diode, and the number of the at least one third diode are equal; or,
the number of the at least one first diode, the number of the at least one second diode, and the number of the at least one third diode are not all equal.

8. The power circuit of claim 1, wherein the storage circuit comprises a capacitor connected to the first output terminal.

9. The power circuit of claim 1, wherein the detection circuit comprises:
a first resistor connected between the voltage input terminal and a first node; and
a second resistor connected between the first node and a ground terminal;
wherein the first node is configured to provide the first polarity signal to the driving circuit.

10. The power circuit of claim 1, wherein the reset image is a black image.

11. The power circuit of claim 1, wherein voltages of source driving signals corresponding to all sub-pixels in the reset image are equal.

12. The power circuit of claim 11, wherein the voltages of the source driving signals corresponding to all sub-pixels in the reset image are zero.

13. A method for driving a power circuit, for driving the power circuit of claim 1, the method comprising:
providing a power voltage to the voltage input terminal during the power-on phase of the display panel, and allowing the display panel to display normally under an action of the driving circuit; and
stopping providing the power voltage to the voltage input terminal during the power-off phase of the display panel, inputting, by the detection circuit, the first polarity signal to the driving circuit, and providing, by the driving circuit, the reset image to the display panel under an effect of a voltage of the storage circuit stored at the first output terminal.

14. The method of claim 13, wherein when the voltage input terminal is connected to a system circuit and a light-emitting voltage circuit in the display device, the method further comprises:
providing the power voltage to the voltage input terminal during the power-on phase of the display panel, providing, by the system circuit, the display data to the driving circuit, and providing, by the light-emitting voltage circuit, the display panel with a power voltage required by the display panel; and
stopping providing the power voltage to the voltage input terminal during the power-off phase of the display panel, stopping, by the system circuit, providing the display data to the driving circuit, and stopping, by the light-emitting voltage circuit, providing the power voltage required by the display panel to the display panel.

15. A display device, comprising:
a display panel;
a driving circuit configured to: provide a source driving signal generated based on display data, and a gate driving signal to the display panel, and input a reset image to the display panel under an effect of a first polarity signal; and
a power circuit of claim 1.

16. The display device of claim 15, further comprising:
a light-emitting voltage circuit configured to provide the display panel with a power voltage required by the display panel; and
a system circuit configured to provide the display data to the driving circuit, wherein the driving circuit is configured to provide the source driving signal to the display panel based on the display data.

17. A display device, comprising:
a display panel;
a driving circuit configured to: provide a source driving signal generated based on display data, and a gate driving signal to the display panel, and input a reset image to the display panel under an effect of a first polarity signal; and
a power circuit configured to: provide a power voltage to the driving circuit during a power-on phase of the display panel, provide the first polarity signal to the driving circuit during a power-off phase of the display panel, and provide a power voltage to the driving circuit within a preset duration after the power-off of the display panel.

18. The display device of claim 17, further comprising:
a light-emitting voltage circuit configured to provide the display panel with a power voltage required by the display panel; and
a system circuit configured to provide the display data to the driving circuit, wherein the driving circuit is configured to provide the source driving signal to the display panel based on the display data;
wherein the power circuit is further configured to: provide a power voltage to the light-emitting voltage circuit during the power-on phase of the display panel; and stop providing the power voltage to the light-emitting voltage circuit during the power-off phase of the display panel; and
wherein the power circuit is further configured to: provide a power voltage to the system circuit during the power-on phase of the display panel; and stop providing the power voltage to the system circuit during the power-off phase of the display panel.
